(19) United States
(12) Patent Application Publication
(10) Pub. No.: US 2009/0050427 A1
(43) Pub. Date: Feb. 26, 2009

(54) BRAKE CALIPER HAVING CHAMFERED CORNERS

(75) Inventor: Philip N. Jedele, Ypsilanti, MI (US)

Correspondence Address: DOBRUSIN & THENNISCH PC, 29 W LAWRENCE ST, SUITE 210, PONTIAC, MI, 48342, US

(73) Assignee: Akebono Corporation ( North America), Elizabethtown, KY (US)

(21) Appl. No.: 12/193,228

(22) Filed: Aug. 18, 2008

Related U.S. Application Data
(60) Provisional application No. 60/957,339, filed on Aug. 22, 2007.

(51) Int. Cl. F16D 55/224

(52) U.S. Cl. 188/370

(57) ABSTRACT

The present invention is predicated upon a brake caliper assembly, comprising a finger portion including a first end that is free and a second end, an inner surface and an outer surface, a cylinder portion including a first end that is free and a second end, an inner surface and an outer surface, and a bridge portion, including an inner surface and an outer surface, for connecting with the second end of the finger portion at a finger corner region having an inner surface and an outer surface, and for connecting with the second end of the cylinder portion at a cylinder corner region having an inner surface and an outer surface, and for defining a continuous surface that includes the inner surfaces of each of the finger portion, the cylinder portion, the finger corner region, the cylinder corner region and the bridge portion, wherein the inner surface of at least one of the finger or cylinder corner regions includes an inclined surface that is generally flat for a span of at least about 2 mm.

### CLAIM OF PRIORITY

The present invention claims the benefit of the priority of the filing date of U.S. Provisional Application Ser. No. 60/957,339 filed Aug. 22, 2007, which is herein incorporated by reference for all purposes.

### FIELD OF THE INVENTION

The present invention is predicated upon systems and methods for improving brake calipers and rotors and more specifically for improving brake caliper deflection and stress response characteristics.

### BACKGROUND OF THE INVENTION

Current vehicle designs have created a need for brake systems having relatively large rotors. In an effort to keep costs and system weights down, brake manufacturers have faced the grueling challenge of optimizing braking capability in larger systems without unduly adding mass or structures that occupy substantial volume. One approach to addressing this packaging issue has been to employ calipers with relatively thin bridges or other sections. However, it has proven difficult to achieve the proper desired balance of stiffness for such designs without involving intricate or costly structures that simultaneously address overhang, mass, thickness, rotor/pad clearance, and thermal dissipation considerations. Because poor performing calipers are a potential source of customer dissatisfaction resulting in warranty costs and loss of future sales, there continues to be a need for reliable calipers that are relatively easy to make.

Examples of efforts in the art toward caliper design are found in U.S. Patent Application Nos. 20050236237 and 20070051568 all herein incorporated by reference for all purposes.

### SUMMARY OF THE INVENTION

The present invention meets the above, especially the need for improved brake caliper deflection and stress condition response needs, by providing an improved brake system for assembly into a vehicle structure. By way of summary, in one aspect, the present invention is directed to a brake caliper assembly that includes a finger portion including a first end that is free, a second end, an inner surface and an outer surface; a cylinder portion including a first end that is free, a second end, an inner surface and an outer surface; and a bridge portion, including an inner surface, an outer surface that connects with the second end of the finger portion at a finger corner region having an inner surface and an outer surface. The bridge portion also connects with the second end of the cylinder portion at a cylinder corner region having an inner surface and an outer surface. The resulting structure defines a continuous inner surface structure that includes the inner surfaces of each of the finger portion, the cylinder portion, the finger corner region, the cylinder corner region, and the bridge portion. The inner surface of at least one of the finger or cylinder corner regions includes an inclined surface that is generally flat for a span of at least about 2 mm.

In another aspect, the present invention contemplates a brake caliper assembly that includes a finger portion, a cylinder portion, and a bridge portion. The finger portion includes a first end that is free and a second end, and an inner surface and an outer surface. The cylinder portion includes a first end that is free and a second end, and inner surface and an outer surface. The bridge portion includes an inner surface and an outer surface for connecting with the second end of the finger portion at a finger corner region having an inner surface and an outer surface. Furthermore, the inner surface and the outer surface of the bridge portion are for connecting with the second end of the cylinder portion at a cylinder corner region that has an inner surface and an outer surface. Yet furthermore, the inner surface and the outer surface of the bridge portion are for defining a continuous surface that includes the inner surfaces of each of the finger portion, the cylinder portion, the finger corner region, the cylinder corner region, and the bridge portion. The inner surface of the finger corner region includes a first inclined surface having a first end and a second end, which surface is generally flat for a span of at least about 2 mm. The first end of the inclined surface is connected to the inner surface of the finger portion by a first arcuate surface that has a first radius. The second end of the inclined surface is connected to the inner surface of the bridge portion by a second arcuate surface that has a second radius that is different from the first radius.

In another aspect, the present invention contemplates a brake caliper assembly that includes a cast iron caliper body and a pad assembly including at least one friction member carried on a support plate that includes a corner region having a flat surface. The cast iron caliper body includes a finger portion including a first end that is free and a second end, and an inner surface and an outer surface, a cylinder portion including a first end that is free and a second end, and inner surface and an outer surface; and a bridge portion. The bridge portion has an inner surface and an outer surface for connecting with the second end of the finger portion at a finger corner region having an inner surface and an outer surface. Furthermore, the inner surface and the outer surface of the bridge portion are for connecting with the second end of the cylinder portion at a cylinder corner region having an inner surface and an outer surface. Yet furthermore, the inner surface and the outer surface of the bridge portion are for defining a continuous generally concave surface that includes the inner surfaces of each of the finger portion, the cylinder portion, the finger corner region, the cylinder corner region, and the bridge portion. The inner surface of each of the finger and cylinder corner regions includes an inclined surface having a first end and a second end, which surface is a generally flat machined surface which is substantially free of a mold texture, for a span of at least about 5 mm. The first end of the inclined surface of the finger corner region is connected to the inner surface of the finger portion by a first arcuate surface having a first radius. The second end of the inclined surface is connected to the inner surface of the bridge portion by a second arcuate surface having a second radius that is different from the first radius. The first end of the inclined surface of the cylinder corner region is connected to the inner surface of the cylinder portion by a first arcuate surface having a first radius, and the second end of the inclined surface of the cylinder corner region is connected to the inner surface of the bridge portion by a second arcuate surface having a second radius that is different from the first radius.

In yet another aspect, any of the aspects of the present invention may be further characterized by one or any combination of the following features: the inner surface of each of the finger and cylinder corner regions includes an inclined surface that is generally flat for a span of at least about 2 mm; the inclined surface is connected to the inner surface of the bridge portion by an arcuate surface; the inclined surface is connected to the inner surface of the at least one of the finger portion or the cylinder portion by a arcuate surface, and the inclined surface is connected to the bridge portion by another arcuate surface; the inclined surface is a machined surface, which is substantially free of a mold texture; the bridge portion and at least one of the finger portion or the cylinder portion are cast iron; the assembly further includes at least two opposing spaced apart friction members disposed between the cylinder portion and the finger portion; the assembly further includes a pad assembly including at least one friction member carried on a support plate that includes a corner region that includes a flat surface for generally opposing the flat surface of the finger corner region; the assembly further includes a pad assembly including at least one friction member carried on a support plate that includes a corner region that includes a flat surface that is substantially parallel to the flat surface of the finger corner region; the inner surface of the inboard corner region includes a first inclined surface having a first end and a second end, which surface is generally flat for a span of at least about 2 mm, the first end of the inclined surface being connected to the inner surface of the cylinder portion by a first arcuate surface having a first radius, and the second end of the inclined surface being connected to the inner surface of the bridge portion by a second arcuate surface having a second radius that is different from the first radius; the ratio of the radius of the arcuate surfaces in at least one of the corner regions is at least about 2:1; for at least one of the inclined surfaces, the width of the flat span of such inclined surface is larger than the value of each radius of the arcuate surfaces; in a brake-off position, the bridge portion includes a first end and a second end that are juxtaposed within a space defined by two opposing support plates having an inner face; or any combination thereof.

### BRIEF DESCRIPTION OF THE DRAWINGS

FIG. 1 is a perspective view of a brake caliper assembly.

FIG. 2 illustrates a side view of an exemplary prior caliper assembly.

FIG. 3 illustrates a side view of a caliper in accordance with the prior art.

### DETAILED DESCRIPTION

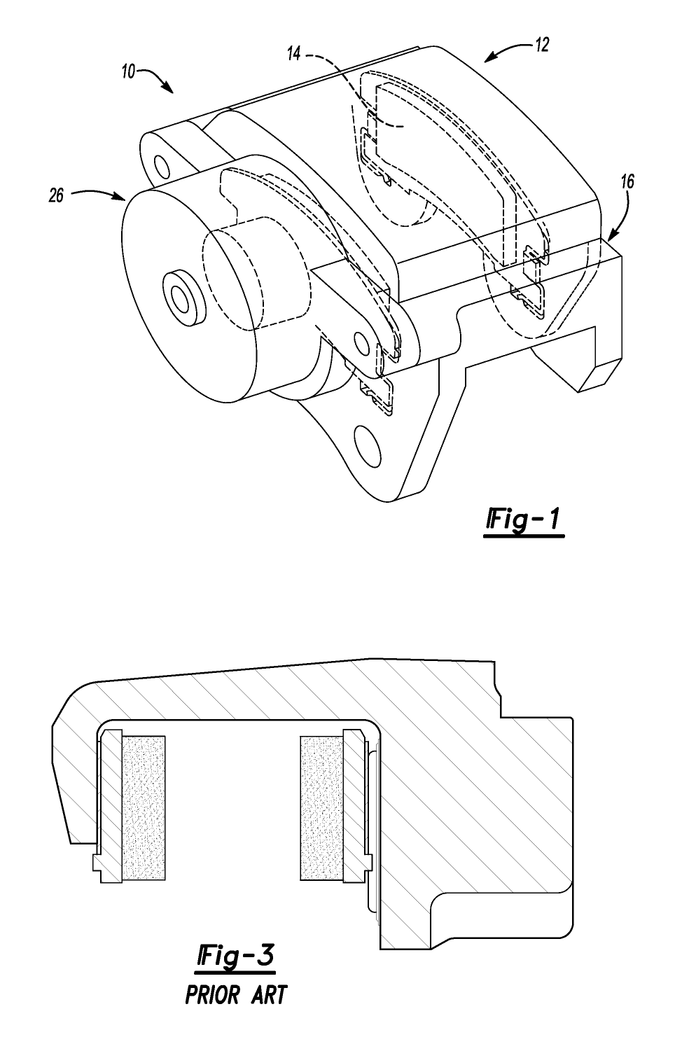

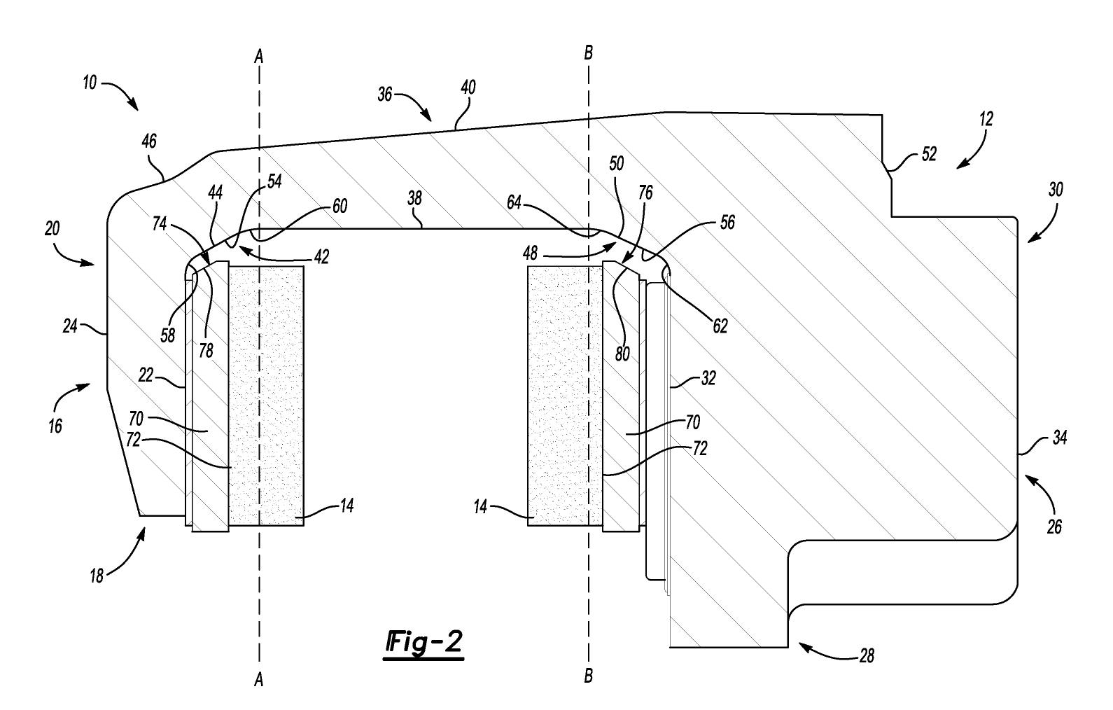

With reference to FIGS. 1 and 2, the present invention provides an improved brake caliper assembly 10 including a body 12 and at least one friction member 14. The body includes a finger portion 16 including a first end 18 that is free and a second end 20, an inner surface 22 and an outer surface 24. A cylinder portion 26 includes a first end 28 that is free, a second end 30, an inner surface 32, and an outer surface 34. A bridge portion 36 includes an inner surface 38 and an outer surface 40. The bridge portion connects with the second end 20 of the finger portion at a finger corner region 42 having an inner surface 44 and an outer surface 46. The bridge portion also connects with the second end 30 of the cylinder portion at a cylinder corner region 48 having an inner surface 50 and an outer surface 52. A continuous generally concave inner surface is thereby defined to include the inner surfaces 22, 32, 38, 44, and 50 of each of the respective finger portion, the cylinder portion, the bridge portion, the finger corner region, and the cylinder corner region.

The inner surface of at least one of the finger or cylinder corner regions includes an inclined surface that is generally flat for a span of at least 2 mm. Thus, for example, both the finger and the cylinder corner regions include an inclined surface 54, 56, respectively, that is generally flat for a span of at least about 2 mm and more specifically at least about 5 mm.

141 The inclined surface of the finger corner region, the cylinder corner region, or both may be connected to the inner surface of the bridge portion by an arcuate surface or one or more other generally flat surfaces. For example, as shown in FIG. 2, the inner surface 44 of the finger corner region 42 may comprise an inclined surface 54 that includes a first end connected to the inner surface 22 of the finger portion by a first arcuate surface 58 having a radius R1. The second end of the inclined surface 54 is connected to the inner surface 38 of the bridge portion by a second arcuate surface 60 having a radius R2 that is the same as or is different from the radius R1. Likewise, the inner surface 50 of the cylinder corner region 48 may comprise a first arcuate surface 62 having a radius R3 and a second arcuate surface 64 having a radius R4 that may be the same or is different from the radius R3. Further, the radiuses R1, R3 of the finger corner region 42 and the cylinder corner region 48 may be the different, though preferably, they are substantially the same. Similarly, the radiuses R2, R4 of the finger corner region 42 and the cylinder corner region 48 may be different, though preferably, they are substantially the same. It is contemplated that the radius ratio for one or both of the arcuate surfaces of the corner regions, (i.e., R2:R1, or R4:R3) may be at least about 2:1 (e.g., 5:2, 3:1, 7:2, or 4:1). Furthermore, it is contemplated that for one or both of the inclined surfaces, the width of the flat span of such inclined surface is larger than the length of at least one if not both, of its associated arcuate surfaces as a result the inclined surfaces are disposed at an angle greater than about 135° relative to the inner surface 38 of the bridge portion. Further, the finger corner region has a lateral span that is larger than typical prior art structures (e.g., as shown in FIG. 3).

It is appreciated that by incorporating a corner region having chamfer (e.g., a flat surface between two different radii), the finger corner region, the cylinder corner region, or both may include a thicker section that is generally located between the outer surface and the inner surface of the respective corner region (e.g., finger corner region or cylinder corner region). A thicker section can improve stress conditions by reducing the occurrence of stress fractures, breakage, or both within the caliper body. The support plate of the pad assembly may also incorporate a chamfer (as discussed herein) to provide appropriate clearance between the finger corner region, the cylinder corner region, or both to the respective support plate having a chamfer corner portion.

In another embodiment of the present invention, the pad assembly is specifically configured to have substantially complementary geometry relative to the caliper. Accordingly, the caliper may further include a pad assembly including at least one friction member carried on a support plate that includes a corner region. In one aspect, the corner region of the pad includes a flat surface for generally opposing (e.g., substantially parallel) the flat surface of the corner region of the finger portion, the cylinder portion, or both.

Further, desired stress response characteristics may be achieved according to the teachings herein by juxtaposing the end of the bridge portion (as shown in FIG. 2 taken across A-A and B-B, respectively) within the space defined between the faces 72 of the support plates 70 in the brake-off position. For example the pad assembly may include a friction member 14 carried on a support plate 70 that includes a first corner region 74 that has a first flat surface 78 for generally opposing the inclined surface 54 of the finger portion corner region. The pad assembly may further include a second friction member 14 carried on a support plate 70 having a second corner region 76 that includes a second flat surface 80 for generally opposing the inclined surface 56 of the cylinder corner region. It is appreciated that at least one of the first flat surface 78 and the second flat surface 80 of the corner regions of the support plates may be generally parallel to the inclined surfaces 54, 56, respectively, of the finger corner region and cylinder corner region. Further, it is appreciated that the first and second flat surfaces 78, 80 may be same or may be different.

In general, the caliper bodies will be made by metal casting followed by machining for achieving the necessary structure detail. The inclined surfaces 54, 56 may be defined in the caliper bodies as a result of the casting, from a subsequent machining step, or both. Preferably, one or both of the inclined surfaces are mill-cut so as to define machined surfaces. Thus, the inclined surfaces (and optionally any associated arcuate end surfaces) will exhibit a topography that is substantially free of a mold texture (e.g., it will be free of a pebbled texture).

It is appreciated by incorporating chamfers in the corner regions of the caliper body and respectively to the support plates of the pad assemblies a reduction in caliper deflection and a reduction in stress of the caliper body is believed possible, as compared with a typical prior art structure such as shown in FIG. 3. As such, the reduction in caliper deflection ranges from about 5 to about 15%, (e.g., such as 9.7%). Additionally, the reduction of stress in the finger portion may range from about 20 to about 40%, (e.g., such as 28.4%), as compared with such a prior art structure. More specifically, the improvement in the reduction of caliper deflection and caliper stress is achieved with relatively inconsequential mass increase (e.g., less than about 60 grams).

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such features may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1) A brake caliper assembly, comprising:
a) a finger portion including a first end that is free and a second end, an inner surface and an outer surface;
b) a cylinder portion including a first end that is free and a second end, an inner surface and an outer surface; and
c) a bridge portion, including an inner surface and an outer surface, for connecting with the second end of the finger portion at a finger corner region having an inner surface and an outer surface, and for connecting with the second end of the cylinder portion at a cylinder corner region having an inner surface and an outer surface, and for defining a continuous surface that includes the inner surfaces of each of the finger portion, the cylinder portion, the finger corner region, the cylinder corner region and the bridge portion;
wherein the inner surface of at least one of the finger or cylinder corner regions includes an inclined surface that is generally flat for a span of at least about 2 mm.

2) The assembly of claim 1, wherein the inner surface of each of the finger and cylinder corner regions includes an inclined surface that is generally flat for a span of at least about 2 mm.

3) The assembly of claim 1, wherein the inclined surface is connected to the inner surface of the bridge portion by an arcuate surface.

4) The assembly of claim 1, wherein the inclined surface is connected to the inner surface of the at least one of the finger portion or the cylinder portion by a arcuate surface, and the inclined surface is connected to the bridge portion by another arcuate surface.

5) The assembly of claim 1, wherein the inclined surface is a machined surface, which is substantially free of a mold texture.

6) The assembly of claim 5, wherein the bridge portion and at least one of the finger portion or the cylinder portion are cast iron.

7) The assembly of claim 1, further comprising at least two opposing spaced apart friction members disposed between the cylinder portion and the finger portion.

8) A brake caliper assembly, comprising:
a) a finger portion including a first end that is free and a second end, and an inner surface and an outer surface;
b) a cylinder portion including a first end that is free and a second end, and inner surface and an outer surface; and
c) a bridge portion having an inner surface and an outer surface for connecting with the second end of the finger portion at a finger corner region having an inner surface and an outer surface, and for connecting with the second end of the cylinder portion at a cylinder corner region having an inner surface and an outer surface, and for defining a continuous surface that includes the inner surfaces of each of the finger portion, the cylinder portion, the finger corner region, the cylinder corner region and the bridge portion;
wherein the inner surface of the finger corner region includes a first inclined surface having a first end and a second end, which surface is generally flat for a span of at least about 2 mm, the first end of the inclined surface being connected to the inner surface of the finger portion by a first arcuate surface having a first radius, and the second end of the inclined surface being connected to the inner surface of the bridge portion by a second arcuate surface having a second radius that is different from the first radius.

9) The assembly of claim 8, further comprising a pad assembly including at least one friction member carried on a support plate that includes a corner region that includes a flat surface for generally opposing the flat surface of the finger corner region.

10) The assembly of claim 8, further comprising a pad assembly including at least one friction member carried on a support plate that includes a corner region that includes a flat surface that is substantially parallel to the flat surface of the finger corner region.

11) The assembly of claim 8, wherein the inner surface of the inboard corner region includes a first inclined surface having a first end and a second end, which surface is generally flat for a span of at least about 2 mm, the first end of the inclined surface being connected to the inner surface of the cylinder portion by a first arcuate surface having a first radius, and the second end of the inclined surface being connected to the inner surface of the bridge portion by a second arcuate surface having a second radius that is different from the first radius.

12) The assembly of claim 11, wherein the ratio of the radius of the arcuate surfaces in at least one of the corner regions is at least about 2:1.

13) The assembly of claim 12, wherein for at least one of the inclined surfaces, the width of the flat span of such inclined surface is larger than the value of each radius of the arcuate surfaces.

14) The assembly of claim 13, wherein the inclined surface is a machined surface, which is substantially free of a mold texture.

15) The assembly of claim 14, wherein the bridge portion and at least one of the finger portion or the cylinder portion are cast iron.

16) A brake caliper assembly, comprising:
a) a cast iron caliper body including:
i) a finger portion including a first end that is free and a second end, and an inner surface and an outer surface;
ii) a cylinder portion including a first end that is free and a second end, and inner surface and an outer surface; and
iii) a bridge portion having an inner surface and an outer surface for connecting with the second end of the finger portion at a finger corner region having an inner surface and an outer surface, and for connecting with the second end of the cylinder portion at a cylinder corner region having an inner surface and an outer surface, and for defining a continuous generally concave surface that includes the inner surfaces of each of the finger portion, the cylinder portion, the finger corner region, the cylinder corner region and the bridge portion;
wherein the inner surface of each of the finger and cylinder corner regions includes an inclined surface having a first end and a second end, which surface is a generally flat machined surface which is substantially free of a mold texture, for a span of at least about 5 mm,
wherein the first end of the inclined surface of the finger corner region is connected to the inner surface of the finger portion by a first arcuate surface having a first radius, and the second end of the inclined surface is connected to the inner surface of the bridge portion by a second arcuate surface having a second radius that is different from the first radius;
wherein the first end of the inclined surface of the cylinder corner region is connected to the inner surface of the cylinder portion by a first arcuate surface having a first radius, and the second end of the inclined surface of the cylinder corner region is connected to the inner surface of the bridge portion by a second arcuate surface having a second radius that is different from the first radius; and
b) a pad assembly including at least one friction member carried on a support plate that includes a corner region that includes a flat surface.

17) The assembly of claim 16, wherein in a brake-off position, the bridge portion includes a first end and a second end that are juxtaposed within a space defined by two opposing support plates having an inner face.

18) The assembly of claim 17, wherein the ratio of the radius of the arcuate surfaces in at least one of the corner regions is at least about 2:1.

19) The assembly of claim 18, wherein for at least one of the inclined surfaces, the width of the flat span of such inclined surface is larger than the value of each radius of the arcuate surfaces.

20) The assembly of claim 19, wherein the pad assembly including a friction member carried on a support plate that includes a corner region that includes a flat surface for generally opposing the flat surface of the finger portion corner region.
